(19) United States
(12) Patent Application Publication
(10) Pub. No.: US 2026/0216911 A1
(43) Pub. Date: Jul. 30, 2026

(54) HANDHELD CUTTING TOOL

(71) Applicant: Nanjing Chervon Industry Co., Ltd., Nanjing (CN)

(72) Inventors: Chengxin Pan, Nanjing (CN); Yang Li, Nanjing (CN)

(21) Appl. No.: 19/413,080

(22) Filed: Dec. 9, 2025

(30) Foreign Application Priority Data
Jan. 24, 2025 (CN) 202520172838.2

(51) Int. Cl. B27B 17/12; B27B 17/02

(52) U.S. Cl. CPC B27B 17/12; B27B 17/02

(57) ABSTRACT

A handheld cutting tool includes a housing; a motor supported by the housing; a saw chain driven by the motor to implement a cutting function; a guide plate for supporting and guiding the saw chain; and an oil tank supported by the housing and configured to store a lubricant to lubricate the saw chain or the guide plate, where the oil tank includes a tank body formed with an oil injection port and a cap for sealing the oil injection port; and the tank body is formed with a protrusion portion capable of shielding at least part of the cap.

### RELATED APPLICATION INFORMATION

This application claims the benefit under 35 U.S.C. § 119(a) of Chinese Patent Application No. 202520172838.2, filed on Jan. 24, 2025, which application is incorporated herein by reference in its entirety.

### TECHNICAL FIELD

The present application relates to the technical field of tools and, in particular, to a handheld cutting tool.

### BACKGROUND

A handheld cutting tool, such as a pole saw, includes an oil tank in which a lubricant is stored. When the pole saw is driven to work, the lubricant in the oil tank may lubricate a saw chain or a guide plate so that the saw chain can more easily perform cutting. Moreover, the lubricant in the oil tank may cool the saw chain to a certain extent, preventing the saw chain from an excessively high temperature.

The oil tank is disposed on a housing of the pole saw, and an oil injection port is sealed by a cap. When the pole saw cuts an object to be cut and located on the upper side of the saw chain, it is possible for the cap to be in contact with the object to be cut and driven to loosen by the object to be cut. Thus, the cap falls off from the oil injection port.

This part provides background information related to the present application, and the background information is not necessarily the existing art.

### SUMMARY

In some examples, a handheld cutting tool includes a housing; a motor supported by the housing; a saw chain driven by the motor to implement a cutting function; a guide plate for supporting and guiding the saw chain; and an oil tank supported by the housing and configured to store a lubricant to lubricate the saw chain or the guide plate, where the oil tank includes a tank body formed with an oil injection port and a cap for sealing the oil injection port; and the tank body is formed with a protrusion portion capable of shielding at least part of the cap.

In some examples, the protrusion portion is disposed around a radial outer side of at least part of the cap.

In some examples, the protrusion portion extends from the tank body towards the top of the cap to exceed a root portion of the cap.

In some examples, the protrusion portion extends from the tank body towards the top of the cap to exceed the top of the cap.

In some examples, a gap between the cap and the protrusion portion is less than or equal to 10 mm.

In some examples, the oil injection port is located on an upper portion of the tank body.

In some examples, the distance between the cap and the top of the housing is greater than or equal to 0 mm and less than or equal to 15 mm.

In some examples, the thickness of the protrusion portion is less than or equal to 5 mm.

In some examples, the upper end of the protrusion portion is flush with or lower than the top of the oil tank.

In some examples, threads mating with each other are formed on the cap and the oil injection port so that the cap seals the oil injection port.

In some examples, the handheld cutting tool includes a connecting rod, the oil tank is located at the front end of the connecting rod, and a handle is provided at the rear end of the connecting rod.

In some examples, the protrusion portion is integrally formed with the tank body.

In some examples, the cap further includes a flip cover, and the flip cover in an open state is not shielded by the protrusion portion.

In some examples, the flip cover includes a rotation stop configured to lock the cap when the flip cover is in a closed state.

In some examples, the handheld cutting tool includes a power supply assembly configured to supply power to the motor.

In some examples, a handheld cutting tool includes a housing; a motor supported by the housing; a saw chain driven by the motor to implement a cutting function; a guide plate for supporting and guiding the saw chain; and an oil tank supported by the housing and configured to store a lubricant to lubricate the saw chain or the guide plate, where the oil tank includes a tank body formed with an oil injection port and a cap for sealing the oil injection port. The handheld cutting tool further includes a stop extending from the tank body towards the top of the cap to exceed a root portion of the cap.

In some examples, the stop is integrally formed with the tank body.

In some examples, a handheld cutting tool includes a housing; a motor supported by the housing; a saw chain driven by the motor to implement a cutting function; a guide plate for supporting and guiding the saw chain; and an oil tank supported by the housing and configured to store a lubricant to lubricate the saw chain or the guide plate, where the oil tank includes a tank body formed with an oil injection port and a cap for sealing the oil injection port. The handheld cutting tool further includes a stop located at the top of the housing or on the oil tank, where in an extension direction of the guide plate, the most front end of the stop is located on the front side of the center of the cap.

In some examples, the center of the cap is a geometric center of the cap.

In some examples, the stop is a protruding structure on the housing or a protrusion portion on the tank body.

In some examples, the distance between the cap and the top of the housing is greater than or equal to 0 mm and less than or equal to 15 mm.

The present application has the following benefits: the protrusion portion is formed on the tank body, and the protrusion portion can shield at least part of the cap, so that when the handheld cutting tool cuts an object to be cut, the protrusion portion prevents the object to be cut from being in contact with the cap or prevents the object to be cut from driving the cap to fall off from the oil injection port. Thus, the cap and the oil injection port mate with relatively good stability.

### BRIEF DESCRIPTION OF THE DRAWINGS

FIG. 1 is a schematic view showing that an existing pole saw cuts an object to be cut.

FIG. 2 is a perspective view of a pole saw according to an example.

FIG. 3 is a side view and a partial enlarged view of the pole saw in FIG. 2.

FIG. 4 is a top view and a partial enlarged view of the pole saw in FIG. 2.

FIG. 5 is a schematic view showing that a motor is included inside the pole saw in FIG. 2.

FIG. 6 is a perspective view of an oil tank in FIG. 2, with a cap removed.

FIG. 7 is a partial side view of the pole saw in FIG. 2, including an oil tank.

FIG. 8A is a perspective view of an oil tank in FIG. 2, including a protrusion portion.

FIG. 8B is a top view of the oil tank in FIG. 8A, including the protrusion portion.

FIG. 9 is a side view of the oil tank in FIG. 8A, including the protrusion portion.

FIG. 10 is a perspective view of a pole saw including a stop according to an example.

FIG. 11 is a perspective view showing that a cap includes a flip cover and the flip cover is in an open state according to an example.

FIG. 12A is a schematic view showing that a cap includes a flip cover and the flip cover includes a rotation stop according to an example.

FIG. 12B is a side view showing that the cap includes the flip cover and the flip cover includes the rotation stop in FIG. 12A.

FIG. 12C is a perspective view of an oil tank without a stop and with a cap including a flip cover according to an example.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a ...” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

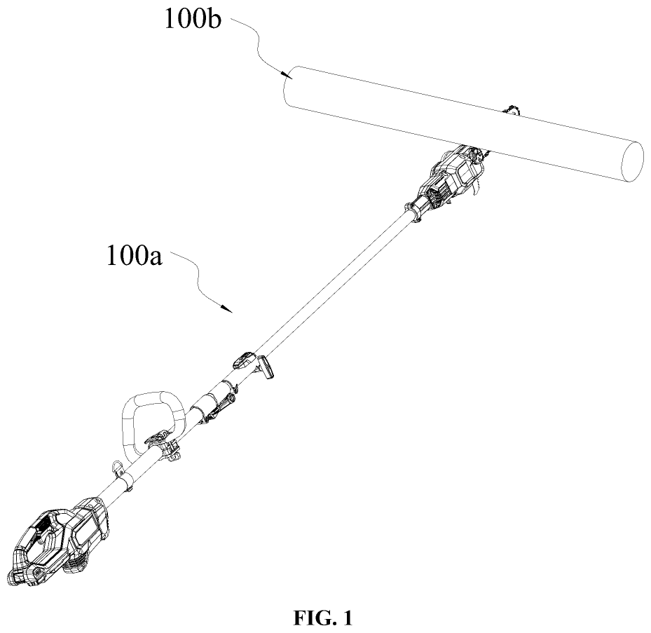

Currently, an existing pole saw 100a includes an oil tank 100c, the oil tank 100c includes an oil injection port and a cap, and the oil injection port and the cap mate with each other through threads. The cap is rotated based on the threads to seal the oil injection port so that a lubricant can be stored in the oil tank. As shown in FIG. 1, when an object to be cut 100b is located on the upper side of the pole saw 100a, as the pole saw 100a performs cutting, the object to be cut 100b moves relative to the pole saw 100a and is likely to touch the oil tank. Further, the object to be cut 100b moves relative to the oil tank. During repeated movement of the object to be cut 100b, it is possible that the cap rotates relative to the oil injection port, causing the loosening of the threads through which the cap and the oil injection port mate with each other. Thus, the cap falls off from the oil injection port, the lubricant stored in the oil tank leaks out, and the pole saw 100a can hardly continue the normal operation. Based on this, the present application provides a pole saw 100 where a cap and an oil injection port mate with relatively good stability, thereby reducing the possibility that the cap is unintentionally rotated and loosened relative to the oil injection port.

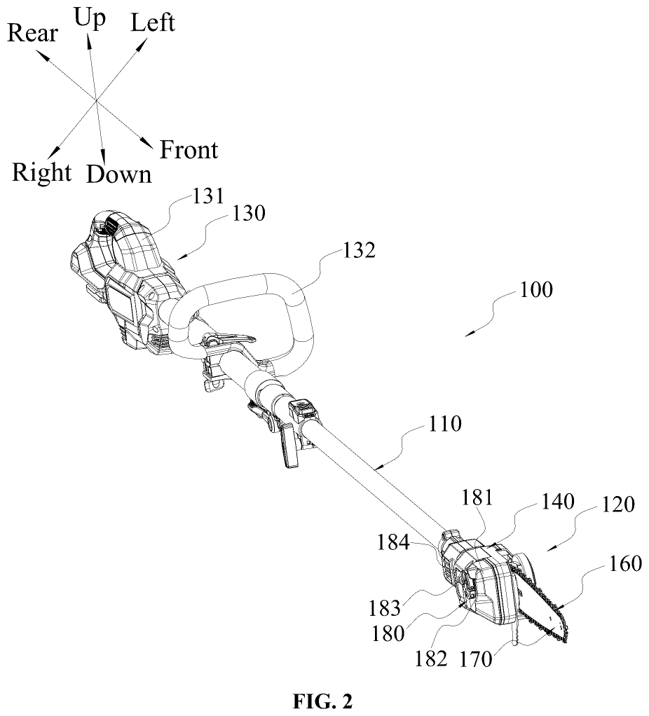

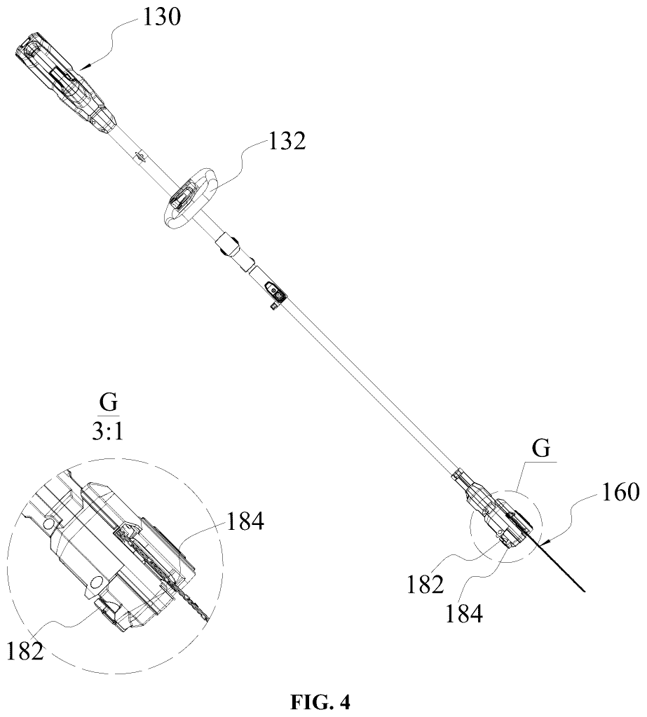

FIGS. 2 to 4 show a handheld cutting tool according to an example of the present application. In this example, the handheld cutting tool is a pole saw 100. It is to be understood that the pole saw 100 is a handheld cutting tool including an oil tank. In other alternative examples, the handheld cutting tool may be another handheld cutting tool including an oil tank, such as a chainsaw. To clearly describe the technical solutions of the present application, an upper side, a lower side, a left side, a right side, a front side, and a rear side are defined, as shown in FIG. 2.

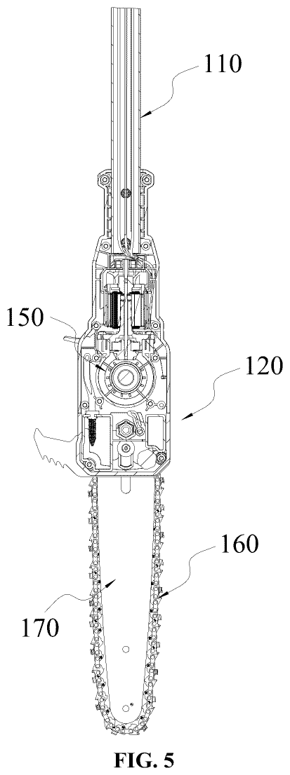

As shown in FIGS. 2 to 5, the pole saw 100 includes a connecting rod 110, a head portion 120, and a tail portion 130. The head portion 120 and the tail portion 130 are distributed at two ends of the connecting rod 110 and connected by the connecting rod 110. The head portion 120 is located at the front end of the pole saw 100, and the tail portion 130 is located at the rear end of the pole saw 100.

The head portion 120 includes a housing 140, a motor 150, a saw chain 160, a guide plate 170, and an oil tank 180. The motor 150 is supported by the housing 140, disposed inside the housing 140, and configured to drive the saw chain 160 to implement a cutting function. The saw chain 160 is disposed around the guide plate 170. The guide plate 170 supports and guides the saw chain 160 so that the saw chain 160 can rotate around the guide plate 170 to perform cutting. The guide plate 170 extends along a front and rear direction. The oil tank 180 is supported by the housing 140 and configured to store a lubricant to lubricate the saw chain 160 or the guide plate 170. The oil tank 180 includes a tank body 181, an oil injection port 182, and a cap 183. The oil injection port 182 is formed on the tank body 181, and the lubricant is injected into the tank body 181 through the oil injection port 182. The cap 183 mates with the oil injection port 182 to seal the oil injection port 182 so that the lubricant does not leak out of the oil tank 180.

A handle 131 is provided on the tail portion 130 and located at the rear end of the pole saw 100. The handle 131 serves as a main handle 131 for a user to hold and operate the pole saw 100. The pole saw 100 further includes an auxiliary handle 132 disposed on the connecting rod 110 and located between the head portion 120 and the tail portion 130. The auxiliary handle 132 is close to the main handle 131 in the front and rear direction so that when the user holds the main handle 131 with one hand, the user can hold the auxiliary handle 132 with the other hand, improving the stability with which the user holds and operates the pole saw 100.

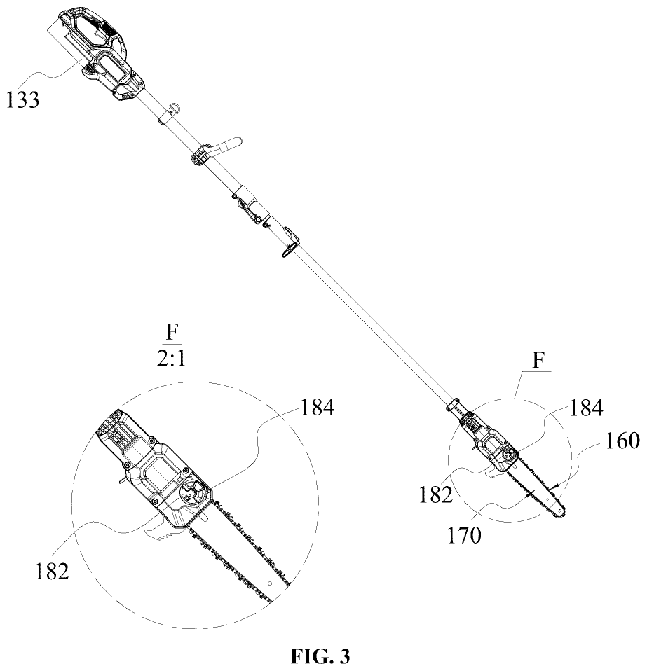

As shown in FIG. 3, the pole saw 100 further includes a power supply assembly 133 configured to supply power to the motor 150. The power supply assembly 133 is disposed on the tail portion 130, the tail portion 130 is formed with a connecting portion mating with the power supply assembly 133, and the power supply assembly 133 mates detachably with the connecting portion. The power supply assembly 133 and the head portion 120 are separately distributed at two ends of the connecting rod 110, achieving a balance in the overall weight of the pole saw 100. In this example, the power supply assembly 133 includes a direct current power supply. For example, the direct current power supply is a battery pack 133. Corresponding components in the pole saw 100 are powered by the battery pack 133 in conjunction with a corresponding power supply circuit. It is to be understood by those skilled in the art that the power supply assembly 133 is not limited to the battery pack 133, and the corresponding components in the machine may be powered by mains electricity or an alternating current power supply in conjunction with corresponding rectifier, filter, and voltage regulator circuits. In this example, the direct current power supply is specifically configured to be the battery pack 133. The battery pack 133 is used hereinafter instead of the direct current power supply, which is not intended to limit the present application.

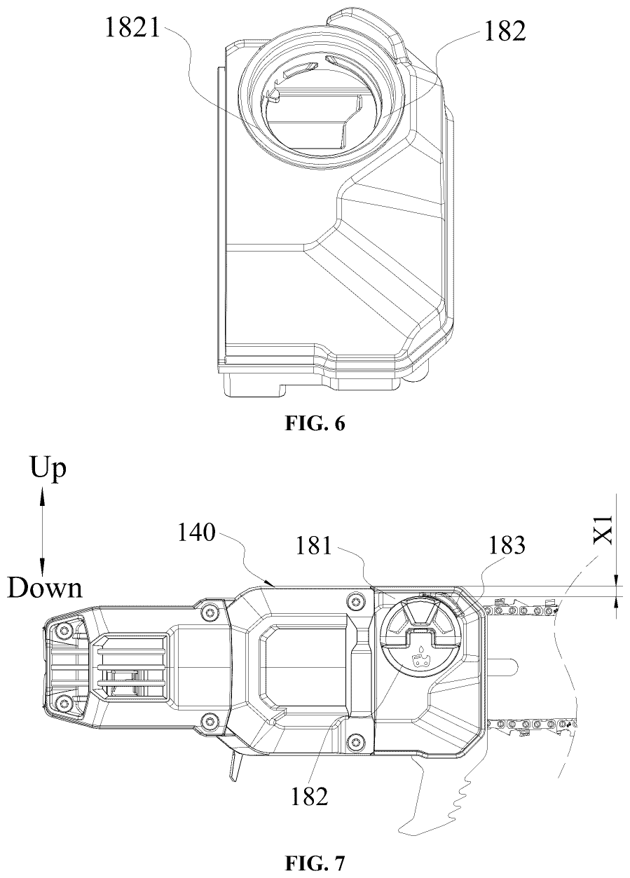

In some examples, as shown in FIG. 6, an oil injection port thread 1821 is formed on the oil injection port 182, and a cap thread (not shown in the figure) mating with the oil injection port thread 1821 is formed on the cap 183, so that the cap 183 and the oil injection port 182 can mate with each other based on the oil injection port thread 1821 and the cap thread. Thus, the cap 183 can be rotated to seal the oil injection port 182, preventing the lubricant stored in the oil tank 180 from leaking out through the oil injection port 182.

In some examples, as shown in FIG. 7, the oil injection port 182 is located on an upper portion of the tank body 181 in an up and down direction, and the oil injection port 182 is at a relatively high position of the tank body 181, that is, the oil injection port 182 is at a relatively high position of the entire pole saw 100. Thus, when the pole saw 100 is in a working state shown in FIG. 2, if the oil tank 180 needs to be supplemented with the lubricant, the user can directly add the lubricant into the oil tank 180 by simply inclining the pole saw 100 at a certain angle and unscrewing the cap 183 off the oil injection port 182. Moreover, since the oil injection port 182 is at a relatively high position, when the lubricant is added, the tank body 181 can accommodate a relatively large amount of lubricant, with no lubricant leaking out through the oil injection port 182. If the oil injection port 182 is disposed in the middle of the tank body 181 or on a lower portion of the tank body 181 in the up and down direction, the user needs to lay the pole saw 100 flat when refilling the lubricant such that the oil tank 180 is almost parallel to a horizontal plane. Then, the oil tank 180 can be supplemented with the lubricant. Otherwise, if the oil tank 180 is only inclined at a certain angle, it is possible for the lubricant to leak out through the oil injection port 182. Moreover, laying the pole saw 100 flat causes inconvenience for the user to directly refill the lubricant. Therefore, in the present application, the oil injection port 182 is disposed on the upper portion of the tank body 181, which makes it more convenient for the user to directly refill the lubricant during use and ensures the capacity of the oil tank 180 when the pole saw 100 is inclined for lubricant refilling.

In some examples, as shown in FIG. 7, the distance X1 between the cap 183 and the top of the housing 140 is greater than or equal to 0 mm and less than or equal to 15 mm. The distance X1 between the cap 183 and the top of the housing 140 is relatively small, that is, the oil injection port 182 is at a relatively high position of the tank body 181. Specifically, the distance X1 refers to the distance between an uppermost end of the cap 183 and the top of the housing 140. Optionally, the distance X1 between the cap 183 and the top of the housing 140 is 3 mm. Optionally, the distance X1 between the cap 183 and the top of the housing 140 is 4.5 mm. Optionally, the distance X1 between the cap 183 and the top of the housing 140 is 6 mm. Optionally, the distance X1 between the cap 183 and the top of the housing 140 is 6.6 mm. Optionally, the distance X1 between the cap 183 and the top of the housing 140 is 12 mm. Optionally, the distance X1 between the cap 183 and the top of the housing 140 is 13.7 mm. In some examples, the tank body 181 is formed with a protrusion portion 184. As shown in FIGS. 2 to 4, the protrusion portion 184 can shield at least part of the cap 183 and is disposed around a radial outer side of at least part of the cap 183. Optionally, the protrusion portion 184 is integrally formed with the tank body 181, where the raised protrusion portion 184 is directly formed by the tank body 181. Alternatively, the protrusion portion 184 is separated from the tank body 181, where the protrusion portion 184 is separately formed and fixedly connected to the tank body 181.

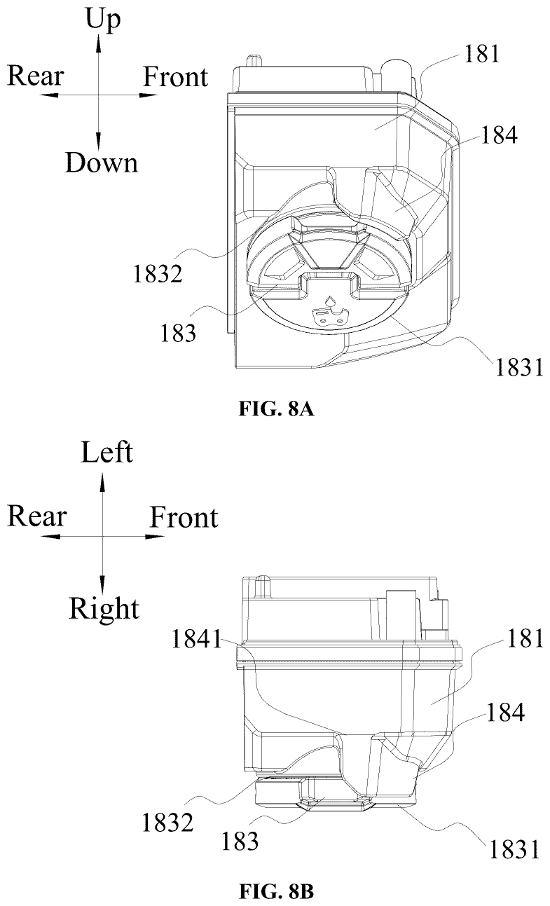

As shown in FIGS. 8A and 8B, the protrusion portion 184 is disposed on the upper side of the cap 183 and extends and protrudes along an axial direction of the tank body 181, that is, the protrusion portion 184 extends and protrudes along a left and right direction. Since the cap 183 protrudes relative to the tank body 181 in the left and right direction and the protrusion portion 184 is disposed on the radial outer side of the cap 183, the protrusion portion 184 can shield at least part of the cap 183 in the front and rear direction and the up and down direction. A shape of the protrusion portion 184 is not limited in the present application and may be any shape such that the protrusion portion 184 can implement the shielding function. Optionally, the protrusion portion 184 may be disposed around a front half of the cap 183. Optionally, the protrusion portion 184 may be disposed around an upper half of the cap 183. Optionally, the protrusion portion 184 may be disposed completely around the cap 183 to more comprehensively prevent the cap 183 from being in contact with the object to be cut and driven to rotate. A specific configuration of the protrusion portion 184 around the cap 183 is not limited in the present application as long as the protrusion portion 184 can at least shield part of the front and upper sides of the cap 183.

In some examples, the protrusion portion 184 extends from the tank body 181 towards a top 1831 of the cap 183 to exceed a root portion 1832 of the cap 183, that is, in the left and right direction, the protrusion portion 184 can shield at least part of the cap 183, and a protruding length of the protrusion portion 184 is less than the width of the cap 183. In some examples, the protrusion portion 184 extends from the tank body 181 towards the top 1831 of the cap 183 to exceed the top 1831 of the cap 183, that is, in the left and right direction, the protrusion portion 184 can shield all of the cap 183, and the protruding length of the protrusion portion 184 is greater than or equal to the width of the cap 183. The width of the cap 183 refers to the length of the cap 183 along the left and right direction. As shown in FIGS. 8A and 8B, a root portion 1841 of the protrusion portion 184 may be closer to the left side of the pole saw 100 than the root portion 1832 of the cap 183. Optionally, the root portion 1841 of the protrusion portion 184 may be closer to the right side of the pole saw 100 than the root portion 1832 of the cap 183. Optionally, the root portion 1841 of the protrusion portion 184 and the root portion 1832 of the cap 183 may be located on the same vertical plane extending along the front and rear direction.

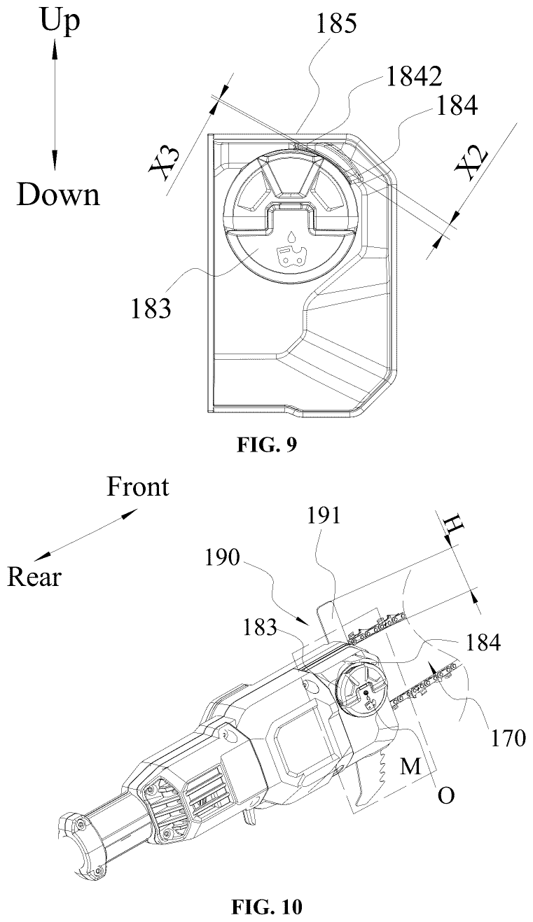

In some examples, in the up and down direction, an upper end 1842 of the protrusion portion 184 is flush with a top 185 of the oil tank 180. In some examples, in the up and down direction, the upper end 1842 of the protrusion portion 184 is lower than the top 185 of the oil tank 180. As shown in FIG. 9, in the up and down direction, the upper end 1842 of the protrusion portion 184 is not higher than the top 185 of the oil tank 180. Thus, the oil tank 180 formed with the protrusion portion 184 is simple in structure and is machined by a simple process in the manufacturing and production process, avoiding a complex machining process and a large production difficulty when the upper end 1842 of the protrusion portion 184 is higher than the top 185 of the oil tank 180. In some examples, as shown in FIG. 9, the thickness X2 of the protrusion portion 184 is less than or equal to 5 mm. When the thickness of the protrusion portion 184 varies, the thickness X2 of the protrusion portion 184 refers to the thickness of a thickest part of the protrusion portion 184. Optionally, the thickness X2 of the protrusion portion 184 is 1.5 mm. Optionally, the thickness X2 of the protrusion portion 184 is 2.3 mm. Optionally, the thickness X2 of the protrusion portion 184 is 3 mm. Optionally, the thickness X2 of the protrusion portion 184 is 4.8 mm. In some examples, as shown in FIG. 9, a gap X3 between the cap 183 and the protrusion portion 184 is less than or equal to 10 mm. Moreover, since the cap 183 needs to be unscrewed off the oil injection port 182, the gap X3 between the cap 183 and the protrusion portion 184 is greater than 0 mm. Optionally, the gap X3 between the cap 183 and the protrusion portion 184 is 2 mm. Optionally, the gap X3 between the cap 183 and the protrusion portion 184 is 4.8 mm. Optionally, the gap X3 between the cap 183 and the protrusion portion 184 is 6 mm. Optionally, the gap X3 between the cap 183 and the protrusion portion 184 is 7.3 mm. Optionally, the gap X3 between the cap 183 and the protrusion portion 184 is 8.5 mm.

The thickness X2 of the protrusion portion 184 and the gap X3 between the cap 183 and the protrusion portion 184 are defined such that the thickness X2 of the protrusion portion 184 is relatively small, and the gap X3 between the cap 183 and the protrusion portion 184 is relatively small, preventing the drawback of a difficulty in unscrewing the cap 183 off the oil injection port 182 due to a relatively large thickness X2 of the protrusion portion 184 and an excessively small distance between the protrusion portion 184 and the cap 183, preventing the drawback of a waste of space in the oil tank 180 since a cavity is formed inside the protrusion portion 184 due to a relatively large thickness X2 of the protrusion portion 184 but the cavity in the protrusion portion 184 cannot store the lubricant, and avoiding a complex machining process and a large production difficulty when the protrusion portion 184 exceeds the top 185 of the oil tank 180 due to an excessively large gap X3 between the cap 183 and the protrusion portion 184 and a relatively large thickness X2 of the protrusion portion 184.

In the present application, the protrusion portion 184 is formed on the tank body 181 so that when the pole saw 100 with the oil injection port 182 and the cap 183 located on the upper portion of the tank body 181 performs cutting, if the object to be cut is located on the upper side of the saw chain 160, the object to be cut is in contact with the protrusion portion 184 and the protrusion portion 184 prevents the object to be cut from being in contact with the cap 183, or even if the object to be cut is in contact with the cap 183, the protrusion portion 184 makes it difficult for the object to be cut to drive the cap 183 to rotate. Thus, the possibility that the cap 183 is in contact with the object to be cut and driven to loosen and fall off from the oil injection port 182 is reduced, and the cap 183 and the oil injection port 182 mate with significantly improved stability.

The pole saw 100 further includes a stop 190, where the stop 190 is disposed at the top of the housing 140 or on the oil tank 180. In an extension direction of the guide plate 170, that is, in the front and rear direction, the most front end of the stop 190 is located on the front side of the center O of the cap 183, where the center O of the cap 183 is a geometric center of the cap 183, that is, a geometric center of a surface of the cap 183. Optionally, the surface of the cap 183 may be a flat surface. Optionally, the surface of the cap 183 may be an uneven surface. The geometric center of the surface of the cap 183 is specifically defined as follows: as shown in FIG. 10, a vertical plane M extends along the front and rear direction and passes through the surface of the cap 183, and the geometric center O of a projection of the surface of the cap 183 on the vertical plane M is the center O of the cap 183. Thus, when the pole saw 100 cuts the object to be cut, the object to be cut is first in contact with the stop 190 in the front and rear direction. The stop 190 prevents the object to be cut from being in contact with the cap 183. Alternatively, the object to be cut may be in contact with the cap 183, but the stop 190 prevents the object to be cut from driving the cap 183 to rotate relative to the oil injection port 182.

In some examples, when the stop 190 is disposed on the tank body 181, the stop 190 extends from the tank body 181 towards the top 1831 of the cap 183 to exceed the root portion 1832 of the cap 183. In this case, the stop 190 is the protrusion portion 184. As shown in FIG. 10, in the front and rear direction, the most front end of the protrusion portion 184 is located on the front side of the center O of the cap 183. The specific structure and related attributes of the stop 190 are the same as those of the protrusion portion 184 of the present application described above and are not repeated here.

In some examples, when the stop 190 is disposed at the top of the housing 140, as shown in FIG. 10, the stop 190 is a protruding structure 191 extending along the up and down direction. In the front and rear direction, the most front end of the protruding structure 191 is located on the front side of the center O of the cap 183. Optionally, the protruding structure 191 may be almost perpendicular to the housing 140, as shown in FIG. 10. Optionally, the protruding structure 191 may be disposed at an angle relative to the housing 140, which is not limited in the present application. Optionally, the protruding structure 191 may be rectangular, as shown in FIG. 10. Optionally, the protruding structure 191 may be a structure whose front end in the front and rear direction includes some saw teeth. Optionally, the protruding structure 191 may be of any other shape as long as the protruding structure 191 can block the object to be cut to a certain extent, which is not limited in the present application. Additionally, the height H of the protruding structure 191 in the up and down direction is not limited in the present application and may be any height as long as the protruding structure 191 can block the object to be cut to a certain extent.

In some examples, the pole saw 100 may be provided with only one stop 190, where the pole saw 100 is provided with the protrusion portion 184 or the protruding structure 191. In some examples, the pole saw 100 may be provided with both two stops 190, where the pole saw 100 is provided with both the protrusion portion 184 and the protruding structure 191.

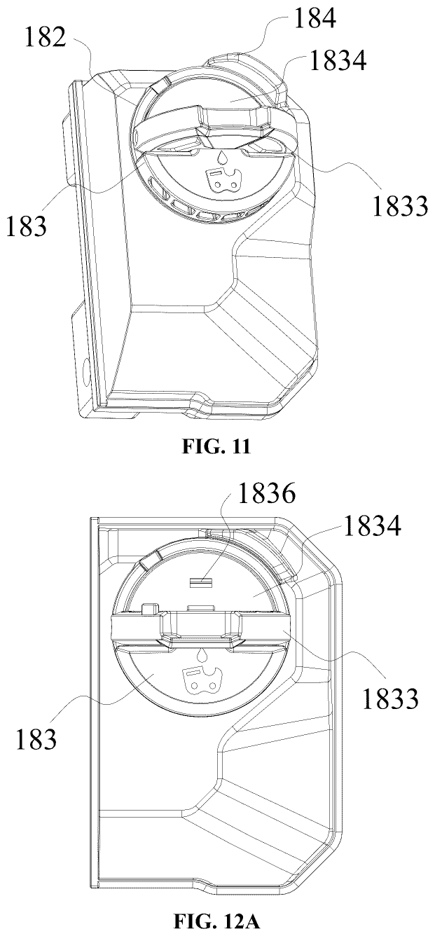

In some examples, the cap 183 includes a flip cover 1833 and a body 1834, and the flip cover 1833 is disposed on an upper half of the cap 183. The flip cover 1833 may be flipped open relative to the body 1834 to be in an open state shown in FIG. 11. When the flip cover 1833 is in the open state, the body 1834 still mates with the oil injection port 182 to seal the oil injection port 182, and the flip cover 1833 is not shielded by the protrusion portion 184. The angle A by which the flip cover 1833 is flipped open relative to the body 1834 is not limited in the present application and may include multiple angles such as 30°, 60°, and 90°. Thus, when the user needs to add the lubricant into the oil tank 180, the user may flip the flip cover 1833 open and rotate the flip cover 1833 to drive the body 1834 to rotate relative to the oil injection port 182, making it convenient for the user to unscrew the cap 183 off the oil injection port 182.

In some examples, a rotation stop 1835 is provided on the flip cover 1833 to loch the flip cover 183, and a fixing member 1836 mating with the rotation stop 1835 is provided on an upper portion of the body 1834. Thus, when the flip cover 1833 is in a closed state and is not flipped open, as shown in FIG. 9, the rotation stop 1835 may mate with the fixing member 1836 to prevent the flip cover 1833 from being opened, thus making it less likely for the user to rotate the cap 183. When a force is applied to the flip cover 1833 along the left and right direction such that the rotation stop 1835 is disengaged from the fixing member 1836, the flip cover 1833 is in the open state, and then the cap 183 can be rotated. Additionally, the fixing member 1836 may be disposed at another position of the tank body 181 where the fixing member 1836 can mate with the rotation stop 1835, or the fixing member 1836 may be disposed at a position of the housing 140 where the fixing member 1836 can mate with the rotation stop 1835, which is not limited in the present application.

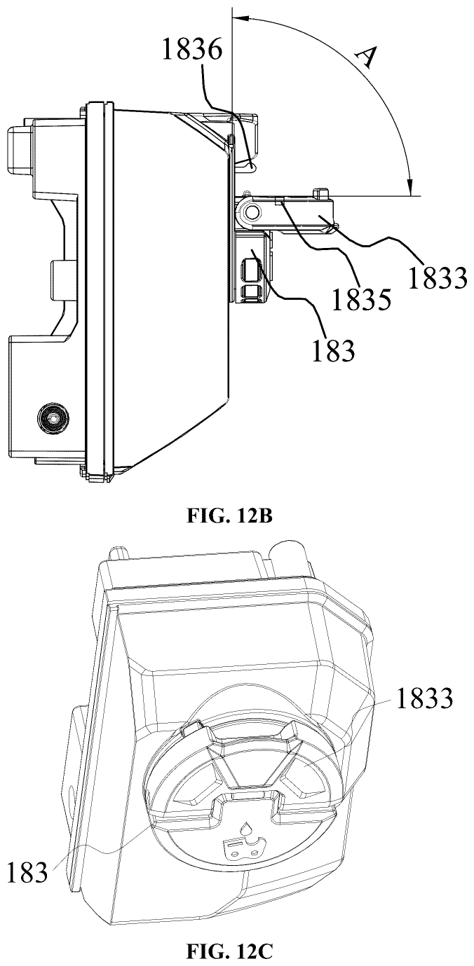

In some examples, as shown in FIGS. 12A and 12B, the rotation stop 1835 is a recess, and the fixing member 1836 is a matching protruding component, which mate with each other to prevent the cap 183 from being rotated. In some examples, the rotation stop 1835 may be a protruding component, and the fixing member 1836 is a matching recess, which mate with each other to prevent the cap 183 from being rotated. Additionally, the rotation stop 1835 and the fixing member 1836 may be other components capable of mating with each other to prevent the cap 183 from being rotated, which are not limited in the present application.

Thus, when the rotation stop 1835 is disposed on the flip cover 1833, as shown in another example of FIG. 12C, when the flip cover 1833 is in the closed state and is not flipped open, the stop 190 does not need to be disposed on the oil tank 180. Even if the cap 183 is in contact with the object to be cut, the object to be cut cannot drive the cap 183 to rotate, thereby improving the stability with which the cap 183 and the oil injection port 182 mate with each other. Alternatively, the pole saw 100 is provided with both the stop 190 and the rotation stop 1835 on the flip cover 1833, further improving the stability with which the cap 183 and the oil injection port 182 mate with each other. In this example, the protrusion portion 184 is not provided. Instead, a groove is formed by the recess of the tank body 181 itself, so that the entire cap 183 is positioned within the groove, thereby ensuring that the cap 183 does not protrude from the tank body 181.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A handheld cutting tool, comprising:
a housing;
a motor supported by the housing;
a saw chain driven by the motor to implement a cutting function;
a guide plate for supporting and guiding the saw chain; and
an oil tank supported by the housing and storing a lubricant to lubricate at least one of the saw chain and the guide plate, the oil tank comprising a tank body, formed with an oil injection port and a protrusion portion, and a cap for sealing the oil injection port, the protrusion portion shielding at least a part of the cap.

2. The handheld cutting tool according to claim 1, wherein the protrusion portion is disposed around a radial outer side of at least part of the cap.

3. The handheld cutting tool according to claim 1, wherein the protrusion portion extends from the tank body towards a top of the cap to exceed a root portion of the cap.

4. The handheld cutting tool according to claim 1, wherein the protrusion portion extends from the tank body towards a top of the cap to exceed the top of the cap.

5. The handheld cutting tool according to claim 1, wherein a gap between the cap and the protrusion portion is less than or equal to 10 mm.

6. The handheld cutting tool according to claim 1, wherein the oil injection port is located on an upper portion of the tank body.

7. The handheld cutting tool according to claim 1, wherein a distance between the cap and a top of the housing is greater than or equal to 0 mm and less than or equal to 15 mm.

8. The handheld cutting tool according to claim 1, wherein a thickness of the protrusion portion is less than or equal to 5 mm.

9. The handheld cutting tool according to claim 1, wherein an upper end of the protrusion portion is flush with or lower than a top of the oil tank.

10. The handheld cutting tool according to claim 1, wherein complimentary threads are formed on the cap and the oil injection port, respectively, so that the cap mates with and seals the oil injection port.

11. The handheld cutting tool according to claim 1, further comprising a connecting rod, wherein the oil tank is located at a front end of the connecting rod, and a handle is provided at a rear end of the connecting rod.

12. The handheld cutting tool according to claim 1, wherein the protrusion portion is integrally formed with the tank body.

13. The handheld cutting tool according to claim 1, wherein the cap further comprises a flip cover, and the flip cover in an open state is not shielded by the protrusion portion.

14. The handheld cutting tool according to claim 13, wherein the flip cover comprises a rotation stop that locks the flip cover when the flip cover is in a closed state.

15. The handheld cutting tool according to claim 1, further comprising a power supply assembly that supplies power to the motor.

16. A handheld cutting tool, comprising:
a housing;
a motor supported by the housing;
a saw chain driven by the motor to implement a cutting function;
a guide plate for supporting and guiding the saw chain;
an oil tank supported by the housing and storing a lubricant to lubricate at least one of the saw chain and the guide plate, the oil tank comprising a tank body formed with an oil injection port and a cap for sealing the oil injection port; and
a stop extending from the tank body towards a top of the cap to exceed a root portion of the cap.

17. A handheld cutting tool, comprising:
a housing;
a motor supported by the housing;
a saw chain driven by the motor to implement a cutting function;
a guide plate for supporting and guiding the saw chain;
an oil tank supported by the housing and storing a lubricant to lubricate at least one of the saw chain and the guide plate, the oil tank comprising a tank body formed with an oil injection port and a cap for sealing the oil injection port; and
a stop located at a top of the housing or on the oil tank where, in an extension direction of the guide plate, a most front end of the stop is located on a front side of a center of the cap.

18. The handheld cutting tool according to claim 17, wherein the center of the cap is a geometric center of the cap.

19. The handheld cutting tool according to claim 17, wherein the stop is a protruding structure on the housing or a protrusion portion on the tank body.

20. The handheld cutting tool according to claim 17, wherein a distance between the cap and the top of the housing is greater than or equal to 0 mm and less than or equal to 15 mm.
